(19) United States
(12) Patent Application Publication
(10) Pub. No.: US 2021/0078103 A1
(43) Pub. Date: Mar. 18, 2021

(54) Method for Laser Beam Welding of One or More Steel Sheets Made of Press-Hardenable Manganese-Boron Steel

(71) Applicant: Baosteel Tailored Blanks GmbH, Duisburg (DE)

(72) Inventors: Jana von der Heydt, Duisburg (DE); Christian Both, Duisburg (DE); Michael Kessler, Bergheim (DE)

(21) Appl. No.: 16/642,267

(22) PCT Filed: Aug. 9, 2018
(86) PCT No.: PCT/EP2018/071573

§ 371 Date: Feb. 26, 2020

(30) Foreign Application Priority Data
Aug. 31, 2017 (DE) 10 2017 120 051.7

(51) Int. Cl. B23K 26/211; B23K 26/24; B23K 26/322

(52) U.S. Cl. CPC B23K 26/211; B23K 2101/18; B23K 26/322; B23K 26/24

(57) ABSTRACT

A method for laser beam welding of one or more steel sheets made of press-hardenable manganese-boron steel is disclosed. At least one of the steel sheets has a coating of aluminium. The laser beam welding takes place by feeding an additional wire into a melt bath generated by of a laser beam. The additional wire contains at least one austenite-stabilising alloy element. The weld seam after hot forming (press hardening) has a strength that is comparable to the base material. The laser beam is put into oscillation such that it oscillates transverse to the welding direction, wherein the oscillation frequency of the laser beam is at least 200 Hz, preferably at least 500 Hz. The method dispenses with removing the aluminum coating at the edge of the sheet-metal edges to be welded.

The invention relates to a method for laser beam welding of one or more steel sheets made of press-hardenable manganese-boron steel, wherein at least one of the steel sheets has a coating made of aluminium and laser beam welding takes place by feeding an additional wire into the melt bath generated exclusively by means of a laser beam, wherein the additional wire contains at least one austenite-stabilising alloy element.

So-called hot formable, press-hardenable steel sheets made of manganese-boron steel, for example the steel grade 22MnB5 are increasingly gaining relevance in automobile manufacture. In the delivery state, i.e. prior to press hardening, manganese-boron steels have a tensile strength of approx. 600 MPa and a ferritic-perlitic microstructure. A fully martensitic microstructure can be set by press hardening and the associated rapid cooling after forming, which can have tensile strengths in the region of 1500 to 2000 MPa.

In order to avoid scaling of the components produced from such steel sheets during hot forming, the relevant steel sheets are usually provided with a coating made of aluminium, for example an aluminium-silicone coating. This surface coating protects the workpieces against oxidation in the furnace and saves an additional cleaning step to remove scale after forming. However, the surface coating affects the quality of weld seams very negatively. Since the aluminium-containing surface coating is also melted, in addition to the base material, by fusion welding the coated steel sheets (e.g. by means of laser beam welding processes during the production of tailored blanks) and therefore aluminium is introduced into the weld seam.

Aluminium is soluble only up to a mass proportion of approx. 10% in iron or steel. In the case of a higher mass proportion, brittle intermetallic phases are formed, which very negatively affect the mechanical-technological properties of the weld seam and can lead to failure of the weld seam even in the case of low stresses. If the aluminium content in the weld seam is between 2 and 10% by weight, intermetallic phases are not formed, but ferritic regions (phases) form, which lead to a reduction of the strength of the weld seam. The strength of the weld seam is in such cases below that of the base material such that failure of the relevant component in the weld seam is to be expected, irrespective of the joined sheet thickness combination. This is considered undesirable or not even permissible according to the specifications of the automobile industry.

In order to prevent the formation of intermetallic phases and ferrite formation, according to the prior art a full or partial removal of the surface coating in the edge region of the sheet edges to be welded together is carried out prior to the welding process by means of mechanical tools or by means of laser ablation (cf. EP 2 007 545 B1). However, an additional process step is required for this at least partial removal of the surface coating which is costly and time consuming and therefore impairs the effectiveness of the production of components of the type described here.

In US 2008/0011720 A1, a laser arc hybrid welding process is described, wherein plates made of manganese-boron steel, which have an aluminium-containing surface layer, are connected to one another in a butt joint, wherein the laser beam is combined with at least one electric arc in order to melt the metal at the butt joint and to weld the plates together. The electric arc is formed by means of a wolfram welding electrode or forms while using an MIG welding burner at the tip of an additional wire. The additional wire may contain elements (e.g. Mn, Ni and Cu) which induce the conversion of the steel into an austenitic microstructure and facilitate the maintenance of the austenitic conversion in the melt bath. Using this hybrid welding process should allow hot-formable plates made of manganese-boron steel to be welded, which are provided with an aluminium-silicone-based coating, without prior removal of the coating material in the region of the weld seam to be produced, and it should still be ensured that aluminium located at the joint edges of the plates does not lead to a reduction of the strength of the component in the weld seam. By providing an electric arc behind the laser beam, the melt bath should be homogenised and therefore local aluminium concentrations greater than 1.2% by weight, which produce a ferritic structure, should be eliminated.

This known hybrid welding process is relatively costly in terms of the energy consumption owing to the production of the electric arc. Furthermore, the welding speed is comparatively low. In addition, a weld seam produced by laser arc hybrid welding has a seam shape unfavourable for further forming which, where appropriate, requires subsequent processing.

The object of the present invention is to indicate a laser beam welding method by means of which aluminium-coated steel sheets made of press-hardened manganese-boron steel can be joined, whose weld seam has a strength comparable to the base material after hot forming (press hardening), wherein the method should be characterised by high productivity and a comparatively low energy consumption.

To achieve this object, a method is proposed having the features indicated in claim 1. Preferred and advantageous configurations of the method according to the invention are indicated in the dependent claims.

The invention provides that in the case of a laser beam welding method of the type mentioned in the introduction, the laser beam is set into oscillation such that it oscillates transverse to the welding direction, wherein the oscillation frequency of the laser beam is at least 200 Hz, preferably at least 500 Hz.

By feeding substantially aluminium-free additional wire with austenite-stabilising properties into the melt bath produced by means of the laser beam, the aluminium introduced into the melt bath by melting the aluminium-containing surface coating is diluted and the weld seam homogenised.

The invention is based on the idea of achieving further homogenisation of the weld seam through an oscillation of the laser beam transverse to the welding direction (linearly or in defined beam figures) and minimising the metallurgical notch to the base material. Through the oscillation of the laser beam an optimised mixing of the introduced aluminium is achieved in the entire weld seam cross-section. Tests have shown that through the oscillation of the laser beam the aluminium coating in the region of the weld seam root is pushed out of the melt bath such that through laser oscillation the influx of aluminium into the melt bath and therefore the aluminium content in the weld seam can be minimised.

The method according to the invention offers cost advantages since with this method the additional process step of removing the aluminium coating in the region of the weld seam of the sheet edges to be welded can be omitted or is omitted. Unlike conventional laser beam welding of aluminium-coated manganese-boron steel sheets after prior decoating of the edges of the sheet edges to be joined in the butt joint, the method according to the invention achieves optimised weld seam geometry in the form of a larger supporting cross-section. This improves in particular the dynamic load-bearing capacity of the weld seam or reduces the material fatigue in the region of the weld seam.

Moreover, the laser beam welding method according to the invention, unlike laser arc hybrid welding, offers the advantage that the laser weld seam produced is relatively narrow and is characterised by an improved seam geometry in particular in the root region.

The method according to the invention can be used not only in the case of joining together a plurality of steel plates of equal or different sheet thickness in the butt joint, of which at least one plate is produced from manganese-boron steel and is provided on one or both sides with a coating made of aluminium, but for example also in the case of laser beam welding of one individual plate or strip-shaped steel sheet made of press-hardened manganese-boron steel, which also has a coating made of aluminium, wherein in the latter case the sheet edges to be welded together are moved towards one another by forming, for example by bending or roll-forming, such that they are ultimately arranged facing one another in the butt joint. Furthermore, it lies also within the meaning of the invention to use the method according to the invention in the case of laser beam welding of one or more steel sheets made of press-hardenable manganese-boron steel in the overlap joint, wherein at least one of the steel sheets is provided on one or both sides with a coating made of aluminium and the laser beam welding taking place by feeding additional wire into the melt bath generated exclusively by means of the laser beam and wherein the additional wire contains at least one austenite-stabilising alloy element.

One configuration of the invention provides that the steel sheet(s) is or are joined during laser beam welding in the butt joint or overlap joint with a gap of less than 0.8 mm, preferably less than 0.6 mm, particularly preferably less than 0.4 mm. A small gap width in the range of a few tenths of a millimetre favours a high welding speed and therefore high productivity of the welding method. In addition, a small gap width in the indicated range favours the optimisation of the seam geometry.

A further configuration of the invention consists of the amplitude of the oscillation of the laser beam being less than 2 mm, preferably less than 1 mm. An amplitude of the laser beam oscillation in this range permits the use of a high welding speed and therefore high productivity of the welding method. The relatively small amplitude of the laser beam oscillation can be achieved by means of compactly-built laser beam installations, preferably by means of a rotating or oscillating deflection mirror.

The oscillation frequency of the laser beam is, in the case of the method according to the invention, preferably in range of 200 Hz to 1.2 kHz, particularly preferably in the range of 300 Hz to 1 kHz. This configuration favours, in the case of high welding speed, an optimised mixing of aluminium that has flowed from the surface coating into the melt bath and a reduction of the metallurgical notch to base material.

In order to achieve a weld seam that is as homogenous as possible with minimal aluminium content and an optimised seam geometry, it is also favourable when the laser beam welding takes place at an advance speed (welding speed) of more than 4 m/min, preferably at an advance speed in the range of 5 to 8 m/min when carrying out the method according to the invention.

According to a further configuration of the invention, the oscillation of the laser beam takes place with a linear, circular or polygonal swing profile. Such swing profiles (beam figures) are favourable for the homogenisation of the weld seam and the reduction of the metallic notch to the base material.

Furthermore, it is proposed that the geometry of the laser weld seam is detected and that the oscillation frequency and/or the amplitude of the oscillating laser beam are varied as a function of the detected geometry of the laser weld seam. This regulation of the oscillation frequency and/or the amplitude of the laser beam as a function of the geometry of the weld seam is preferably carried out as an automatic regulation using a sensor device detecting the geometry of the weld seam, a computer to evaluate the measurement signals of the sensor device and an actuating device controlled by the computer to control a laser beam oscillator, e.g. of a rotating or oscillating deflection mirror. A high weld seam quality is hereby ensured with high productivity.

In a preferred configuration of the invention, the steel sheet(s) to be welded are selected such that their base material (manganese-boron steel) has the following composition: 0.10 to 0.50% by weight C, max. 0.40% by weight Si, 0.50 to 2.00% by weight Mn, max. 0.025% by weight P, max. 0.010% by weight S, max. 0.60% by weight Cr, max. 0.50% by weight Mo, max. 0.050% by weight Ti, 0.0008 to 0.0070% by weight B, and min. 0.010% by weight Al, remainder Fe and unavoidable impurities. The components produced from such a steel have a relatively high tensile strength after press hardening.

Manganese-boron steel sheets, which have a tensile strength in the range of 1500 to 2000 MPa after press hardening, are particularly preferably used in the method according to the invention.

A further advantageous configuration of the invention provides that the additional wire used in the laser beam welding method has a carbon mass proportion of at least 0.1% by weight, preferably at least 0.3% by weight. The hardenability of the weld seam is hereby improved.

The additional wire used in the method according to the invention preferably has the following composition: 0.1 to 0.4% by weight C, 0.5 to 2.0% by weight Si, 1.0 to 2.5% by weight Mn, 0.5 to 5.0% by weight Cr+Mo and 1.0 to 4.0% by weight Ni, remainder iron and unavoidable impurities. Tests have shown that a full conversion of the weld seam into a martensitic microstructure can be very reliably ensured with such an additional wire using the method according to the invention during press hardening of the joined steel sheets.

A further advantageous configuration of the invention is characterised in that the additional wire is heated prior to being supplied into the melt bath at least in a longitudinal section at a temperature of at least 50° C., preferably at least 90° C. A higher process speed or a higher productivity can hereby be achieved. In particular, not as much energy has to be expended with the laser beam in order to melt the additional wire. In addition, the heating of the additional wire favours the homogenisation of the weld seam.

In order to prevent the embrittling of the weld seam, a further configuration of the method according to the invention provides that inert gas is applied to the melt bath during the laser beam welding. The inert gas used is preferably pure argon, helium, nitrogen or their mixture or a mixture of argon, helium, nitrogen and/or carbon dioxide and/or oxygen.

The steel sheets used in the method according to the invention have a sheet thickness which is for example in the range of 0.5 to 4 mm, preferably in the range of 0.8 to 2.5 mm. The steel sheets can in this case have a different sheet thickness and/or a different tensile strength.

The invention is explained in detail below on the basis of a drawing representing a plurality of exemplary embodiments, wherein:

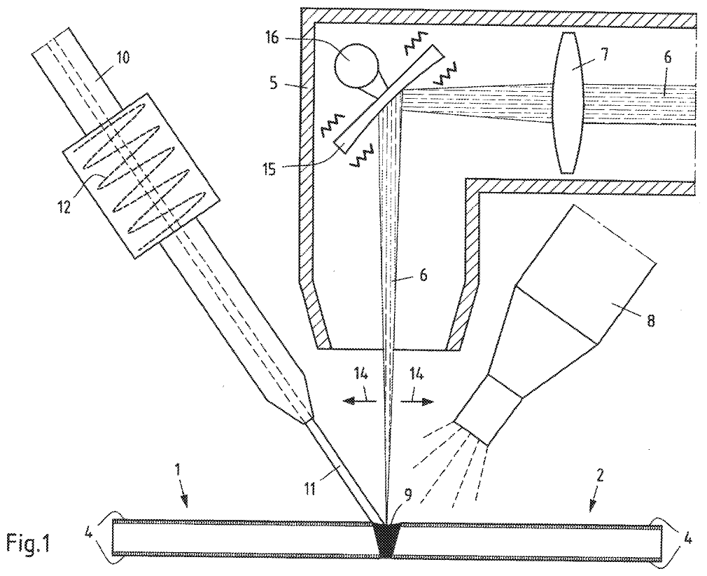

FIG. 1 shows a schematic representation of parts of a device for carrying out the laser beam welding method according to the invention, partially in a vertical sectional view, wherein two press-hardenable steel plates of equal thickness are welded together;

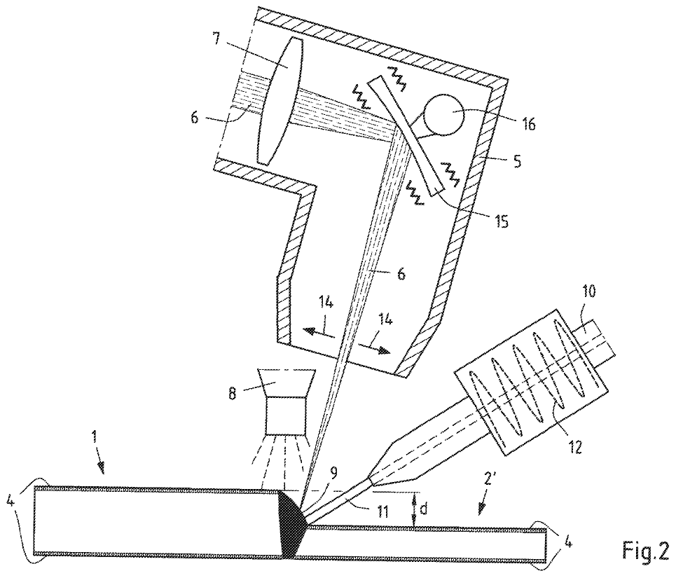

FIG. 2 shows a schematic representation of parts of a device for carrying out the laser beam welding method according to the invention, partially in a vertical sectional view, wherein two press-hardenable steel plates of different thickness are welded together; and

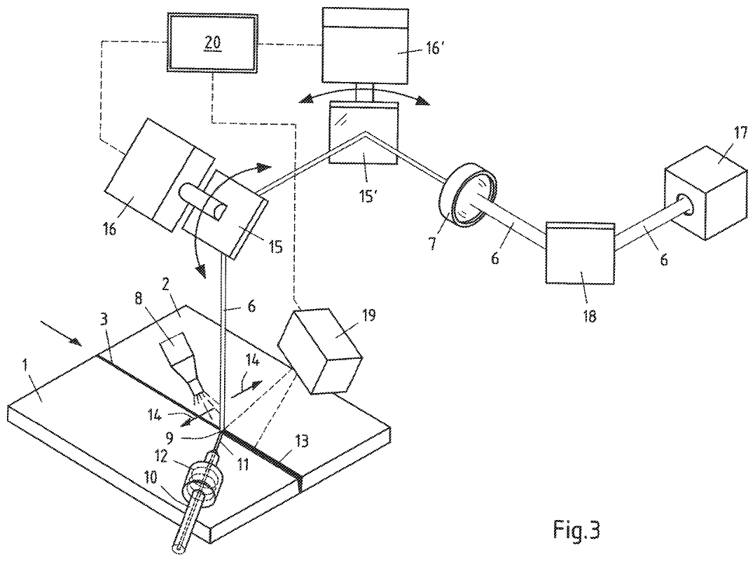

FIG. 3 shows a perspective, schematic representation of parts of a device for carrying out the laser beam welding method according to the invention, wherein two press-hardenable steel plates in turn are welded together.

A laser beam welding device is sketched in FIG. 1, by means of which the method according to the invention can be carried out. The device comprises an underlay (not shown) on which two strips or plates 1, 2 made of steel of equal or different material qualities are arranged such that their edges to be welded together lie to one another as a butt joint. At least one of the steel sheets 1, 2 is produced from press-hardenable manganese-boron steel. The steel sheets 1, 2 are joined with a gap 3 of a few tenths of a millimetre in the butt joint (cf. FIG. 3). The gap 3 is for example less than 0.6 mm, preferably less than 0.4 mm. As far as the steel sheets 1, 2 are produced from steel of different material qualities, one steel sheet 1 or 2 for example has a relatively soft deep-drawing grade, while the other steel sheet 2 or 1 consists of higher strength steel.

The press-hardenable steel, of which at least one of the steel sheets 1, 2 to be connected to one another for example in the butt joint consists, can for example have the following chemical composition:
Max. 0.45% by weight C,
Max 0.40% by weight Si,
Max 2.0% by weight Mn,
Max 0.025% by weight P,
Max 0.010% by weight S,
Max 0.8% by weight Cr+Mo,
Max 0.05% by weight Ti,
Max 0.0050% by weight B, and
Min 0.010% by weight Al,
Remainder iron and unavoidable impurities.

In the delivery state, i.e. prior to a heat treatment and rapid cooling, the press-hardenable steel plates 1, 2 have a yield strength Re of preferably at least 300 MPa; their tensile strength Rm is e.g. at least 480 MPa, and their elongation at break A₈₀ is preferably at least 10%. Following hot forming (press hardening), i.e. heating to austenitization temperature of approx. 900 to 950° C., forming at this temperature and subsequent rapid cooling, the steel plates 1, 2 have a yield strength Re of approx. 1100 MPa, a tensile strength Rm of approx. 1500 to 2000 MPa and an elongation at break A₈₀ of approx. 5.0%.

The steel sheets 1, 2 are provided with a metallic coating 4 made of aluminium. It is preferably an Al—Si coating. The metallic coating 4 is applied to the base material on both sides, for example by hot dip coating, by guiding a strip made of press-hardenable manganese-boron steel through a Al—Si melt bath, blowing off excessive coating material from the strip and the coated strip then subsequently treated, in particular heated. The aluminium content of the coating 4 can be in the range of 70 to 90% by weight.

Alternatively, also only one of the steel sheets 1, 2 to be welded can have an aluminium coating 4. Furthermore, the aluminium coating 4 may, where appropriate, be applied only on one side of the steel sheet(s) 1, 2, e.g. by means of physical vapour deposition (PVD) or by means of an electrolytic coating process.

The steel sheets 1, 2 are for example substantially the same thickness in the exemplary embodiment shown in FIG. 1. The sheet thickness is for example in the range of 0.8 to 3.0 mm, wherein the thickness of the coating on the respective sheet side is less than 100 μm, in particular less than 50 μm.

A section of a laser beam welding head 5 is sketched above the steel sheets 1, 2, which is provided with optics to form and align a laser beam 6, in particular a focussing lens 7. The laser beam 6 is generated for example by means of an Nd:YAG laser system which delivers an output for example in the range of 5 to 6 kW.

A line 8 for feeding inert gas is assigned to the laser beam welding head 5. The discharge of the inert gas line 8 is substantially directed to the melt bath 9 generated with the laser beam 6. Pure argon or for example a mixture of argon, helium and/or carbon dioxide is preferably used as the inert gas.

In addition, a wire feeding device 10 is assigned to the laser beam welding head 5 by means of which a special additional material in the form of a wire 11 is supplied to the melt bath 9, which is also melted by the laser beam 6. The additional wire 11 is supplied to the melt bath 9 preferably in a heated state. To this end, the wire feeding device 10 is equipped with at least one heating element 12, for example a heating spiral surrounding the wire 11. Using the heating element, the additional wire 11 is preferably heated to a temperature of at least 50° C., particularly preferably to at least 90° C.

The additional wire 11 contains substantially no aluminium. It has for example the following chemical composition:
0.1% by weight C,
0.8% by weight Si,
1.8% by weight Mn,
0.35% by weight Cr,
0.6% by weight Mo, and
2.25% by weight Ni,
Remainder iron and unavoidable impurities.

The additional wire 11 is supplied to the melt bath 9 generated by means of the laser beam 6 in order to reduce the mass content of the aluminium introduced into the melt bath 9 by melting the coating 4 and to homogenise the melt bath 9 or the weld seam. The additional wire 11 contains austenite-stabilising alloy elements.

The manganese content of the additional wire 11 is in this case always higher than the manganese content of the base material of the coated steel sheets 1, 2. The manganese content of the additional wire 11 is preferably approx. 0.2% by weight higher than the manganese content of the base material of the coated steel sheets 1, 2. Furthermore, it is favourable when the content of chromium and molybdenum of the additional wire 11 is higher than in the base material of the steel sheets 1, 2. The combined chromium-molybdenum content of the additional wire 11 is preferably approx. 0.2% by weight higher than the combined chromium-molybdenum content of the base material of the steel sheets 1, 2. The nickel content of the additional wire 11 is preferably in the range of 1 to 4% by weight. In addition, the additional wire 11 preferably has a carbon content of at least 0.1% by weight, particular preferably at least 0.3% by weight.

In order to achieve further homogenisation of the weld seam and to reduce the metallic notch to the base material, the laser beam 6 is set into oscillation such that it oscillates at high frequency transverse to the welding direction.

The oscillation of the laser beam 6 is indicated in FIG. 1 by the arrows 14 directed transverse to the joint. The oscillation frequency of the laser beam 6 is at least 200 Hz, preferably at least 500 Hz, particularly preferably at least 600 Hz. The oscillation of the laser beam 6 is for example caused by means of a diversion mirror (deflection mirror) 15, which is provided with an actuator 16 setting the mirror 15 into high-frequency oscillations, for example a piezo drive (piezo actuator). The diversion mirror 15 can also be advantageously configured as a focussing mirror.

The amplitude of the laser beam oscillation is preferably less than 2 mm. When joining the steel sheet plates 1, 2 with a gap 3 of a few tenths of a millimetre, e.g. a gap width in the range of 0.9 to 0.2 mm, the amplitude of the oscillation of the laser beam can for example be in the range of 1.5 to 0.5 mm. The oscillation of the laser beam 6 is carried out with a determined oscillation profile (beam figure). The actuator assigned to the diversion mirror (deflection mirror) 15 and the support of the diversion mirror 15 are preferably configured or settable such that the oscillation of the laser beam 6 has a linear, circular or polygonal oscillation profile. The circular beam figure can in this case have a circular-ring, oval or 8-shaped oscillation profile contour. The polygonal beam figure can, in contrast, in particular have a triangular, rectangular or trapezoidal oscillation profile contour. The support of the diversion mirror 15 capable of oscillating is for example implemented by means of a spring-elastic suspension and/or a fixed body joint.

The steel sheets 1, 2 are welded at an advance speed of preferably more than 4 m/min, for example at an advance speed in the range of 5 to 6 m/min, wherein either the steel sheets 1, 2 are moved by means of a movable underlay relative to the laser beam 6 or the laser beam 6 is moved by means of a robot arm relative to the steel sheets 1, 2. In this case a superimposition of the oscillation profile of the laser beam 6 with the advance movement of the steel sheets 1, 2 or the laser beam welding head 5 arises.

The embodiment sketched in FIG. 2 differs from the example shown in FIG. 1 in that the steel sheets 1, 2′ have different thicknesses such that a thickness jump d is present at the butt joint. For example, the steel sheet 2′ has a sheet thickness in the range of 0.8 mm to 1.2 mm, while the other steel sheet 1 has a sheet thickness in the range 1.6 mm to 3.0 mm. Moreover, the steel sheets 1, 2′ to be connected to one another in the butt joint can also differ from one another in their material quality. For example, the thicker plate 1 is produced from a higher-strength steel, whereas the thinner steel plate 2′ has a relatively soft deep-drawing grade. The steel sheets 1, 2′ are also joined together with a gap of a few tenths of a millimetre.

The laser beam welding device used to join the steel sheets 1, 2′ corresponds substantially to the laser beam welding device sketched in FIG. 1, such that in terms of the configuration of this device, reference is made to the preceding description.

A further exemplary embodiment of a device for carrying out the laser beam welding method according to the invention is sketched in FIG. 3. The laser beam welding device comprises a laser beam generator 17, whose laser beam 6 is guided by means of a deflection mirror 18 or the like to a focussing lens 7. The focussed laser beam 6 is then guided by means of at least one oscillating deflection device to the joint, delimiting a smaller gap 3, of the steel sheets 1, 2 to be welded together in the butt joint. The oscillating deflection device can be formed in this case by one or a plurality of deflection mirrors 15, 15′. The deflection mirror 15, 15′ is provided with an oscillation actuator 16, 16′ for example a piezo drive.

An additional material having austenite-stabilising properties in the form of a wire 11 is supplied to the melt bath 9 generated exclusively by means of the oscillating laser beam 6 via a wire feeding device 10, wherein the tip of the additional wire melts in the melt bath 9 or in the working point of the laser beam 6. By means of a gas supply line 8, whose outlet opening is directed to the melt bath 9, inert gas, e.g. argon and/or helium is applied to this melt bath.

Furthermore, the laser beam welding device according to FIG. 3 has a device by means of which the geometry of the weld seam 13 is detected and the oscillation frequency and/or the amplitude of the oscillating laser beam 6 are automatically varied as a function of the detected geometry of the weld seam 13. The geometry of the laser weld seam is for example detected by means of a sensor device 19 which has a camera and a laser line illumination, wherein the geometry of the weld seam 13, in particular different height profiles and their positions, are detected according to the triangulation method. Alternatively or additionally, the geometry of the weld seam 13 can also be detected by means of inductive measurement methods, in particular eddy current testing or an eddy current probe. The measurement signals of the sensor device are transferred to a computer 20, which evaluates the measurement signals and controls the oscillation actuator(s) 16, 16′ as a function of the measurement signals of the sensor device.

The implementation of the invention is not limited to the exemplary embodiments sketched in the drawing. In fact, numerous variants are conceivable which make use of the invention also in the case of a design differing from the sketched examples, as is indicated in the enclosed claims. It is in particular in the scope of the invention to combine together individual or a plurality of the features of the exemplary embodiments explained on the basis of FIGS. 1 to 3.

### LIST OF REFERENCE NUMERALS

1 Steel sheet (plate)
2 Steel sheet (plate)
2′ Steel sheet (plate)
3 Gap
4 Metallic coating made of Al, e.g. Al—Si
5 Laser beam welding head
6 Laser beam
7 Focussing lens
8 Supply line for inert gas
9 Melt bath
10 Wire feeding device
11 Additional wire
12 Heating element
13 Weld seam
14 Arrows
15, 15′ Diversion mirror (deflection mirror)
16, 16′ Actuator
17 Laser beam generator
18 Deflection mirror
19 Sensor device
20 Computer (controller)
d Thickness jump

1. A method for laser beam welding of one or more steel sheets made of press-hardenable manganese-boron steel, wherein at least one of the steel sheets has a coating made of aluminium, comprising:
feeding an additional wire into a melt bath generated by a laser beam,
wherein the additional wire contains at least one austenite-stabilising alloy element,
wherein the laser beam is set into oscillation such that the laser beam oscillates transverse to a welding direction,
and wherein oscillation frequency of the laser beam is at least 200 Hz.

2. The method according to claim 1, wherein the one or more steel sheets are joined during laser beam welding in a butt joint or an overlap joint with a gap of less than 0.8 mm.

3. The method according to claim 1, wherein an amplitude of the oscillation of the laser beam is less than 2 mm.

4. The method according to claim 1, wherein the laser beam welding is carried out at an advance speed of more than 4 m/min.

5. The method according to claim 1, wherein the oscillation of the laser beam is carried out with a linear, circular, or polygonal oscillation profile.

6. The method according to claim 1, wherein a geometry of a weld seam is detected, and wherein at least one of the oscillation frequency and an amplitude of the oscillating laser beam is varied as a function of the detected geometry of the weld seam.

7. The method according to claim 1, wherein the additional wire has a carbon mass proportion of at least 0.1% by weight.

8. The method according to claim 1, wherein the additional wire has the following composition:
0.1 to 4.0% by weight C,
0.5 to 2.0% by weight Si,
1.0 to 2.5% by weight Mn,
0.5 to 2.0% by weight Cr+Mo,
1.0 to 4.0% by weight Ni, and
remainder iron and unavoidable impurities.

9. The method according to claim 1, wherein the additional wire is heated prior to the feeding into the melt bath at least in a longitudinal section to a temperature of at least 50° C.

10. The method according to claim 1, wherein inert gas is applied to the melt bath during the laser beam welding.

11. The method according to claim 1, wherein the one or more steel sheets have a sheet thickness in the range of 0.5 to 4 mm.

12. The method according to claim 1, wherein the one or more steel sheets have at least one of a different sheet thickness and a different tensile strength.

13. The method according to claim 1, wherein the oscillation frequency is at least 500 Hz.

14. The method according to claim 2, wherein the gap is less than 0.6 mm.

15. The method according to claim 2, wherein the gap is less than 0.4 mm.

16. The method according to claim 3, wherein the amplitude of the oscillation of the laser beam is less than 1 mm.

17. The method according to claim 4, wherein the laser beam welding is carried out at an advance speed in the range of 5 to 8 m/min.

18. The method according to claim 7, wherein the additional wire has a carbon mass proportion of around at least 0.3% by weight.

19. The method according to claim 9, wherein the additional wire is heated prior to the feeding into the melt bath at least in a longitudinal section to a temperature of at least 90° C.

20. The method according to claim 11, wherein the at least one or more steel sheets have a sheet thickness in the range of 0.8 to 2.5 mm.
